(19) United States
(12) Patent Application Publication
(10) Pub. No.: US 2024/0115445 A1
(43) Pub. Date: Apr. 11, 2024

(54) PATIENT WEIGHT SENSING ON AN OPERATING TABLE

(71) Applicant: Baxter Medical Systems GmbH + Co. KG, Saalfeld (DE)

(72) Inventors: Mark A. Sutherland, Sterling, MA (US); David Hitchcock, Westford, MA (US); Juan Nogueira, Munchen (DE); Heather Kooiker, Caledonia, MI (US); Timothy A. Lane, Greensburg, IN (US)

(21) Appl. No.: 18/377,363

(22) Filed: Oct. 6, 2023

Related U.S. Application Data
(60) Provisional application No. 63/414,007, filed on Oct. 7, 2022.

(51) Int. Cl. A61G 7/05; A61G 7/018; A61G 7/10

(52) U.S. Cl. CPC A61G 7/0527; A61G 7/018; A61G 7/0528; A61G 7/1046; A61G 2203/34

(57) ABSTRACT

A patient operating table includes a patient support mattress for supporting a patient's weight. A base frame supports the patient support mattress. A plurality of caster assemblies are connected to the base frame. Each caster assembly includes at least one caster wheel and a strain sensor plate with a first weight bearing side that includes a flex spring with an annular shape that is located at least partially within an outer perimeter of the stain sensor plate and a second weight bearing side. The first weight bearing side is operably coupled to the at least one caster wheel and the second weight bearing side is operably coupled to the base frame support. As such, weight imparted from the base frame passes from the second weight bearing side to the first weight bearing side.

### CROSS-REFERENCE TO RELATED APPLICATION

This application claims priority to and the benefit under 35 U.S.C. § 119(e) of U.S. Provisional Application No. 63/414,007, filed on Oct. 7, 2022, entitled “PATIENT WEIGHT SENSING ON AN OPERATING TABLE,” the disclosure of which is hereby incorporated herein by reference in its entirety.

### BACKGROUND OF THE DISCLOSURE

### 1. Field of the Disclosure

The present disclosure generally relates to a patient table with a weight sensing system. More particularly, the present disclosure relates to a strain sensor plate coupled to a caster wheel. The present disclosure also relates to determining a patient's weight based on a magnitude of displacement or deformation of the strain sensor plate.

### 2. Background of Related Art

For many medical settings it is desirable to accurately monitor the weight of a patient confined to a support surface, such as a bed, operating table, surgical table and/or the like. The observation of weight can be used for dosing, other substance administration, and medical considerations. In addition, monitoring for changes in the patient's weight can be utilized to determine various medical conditions, such as fluid retention, dehydration, blood loss, and/or the like.

The importance of accurately monitoring the weight of a patient confined to a support surface has resulted in various prior art techniques. For example, U.S. Pat. No. 7,472,440 describes a weight monitoring system for a patient support surface that includes load cells mounted on caster wheels that provide a current or voltage output proportional to a supported weight. While the weight monitoring system can obtain and record both the weight and changes to the weight accurately in certain scenarios there are certain drawbacks. For example, certain types of load cells may be prone to failure, anomalies, or degradation and there are different scenarios where the load cell reading can be inaccurate. For example, if the patient support surface is on an incline, the patient weight may not be equally distributed between two or more load cells, resulting in inaccuracies to the weight measurement.

Accordingly, the present disclosure provides a strain sensor plate with an improved architecture and a system for ensuring that the weight measurement is accurate in different scenarios.

### SUMMARY OF THE DISCLOSURE

According to one aspect of the present disclosure, a patient operating table includes a patient support mattress for supporting a patient's weight. A base frame supports the patient support mattress. A plurality of caster assemblies are connected to the base frame. Each caster assembly includes at least one caster wheel and a strain sensor plate with a first weight bearing side that includes a flex spring with an annular shape that is located at least partially within an outer perimeter of the stain sensor plate and a second weight bearing side. The first weight bearing side is operably coupled to the at least one caster wheel and the second weight bearing side is operably coupled to the base frame support. As such, weight imparted from the base frame passes from the second weight bearing side to the first weight bearing side.

According to another aspect of the present disclosure, a caster assembly for a patient operating table includes at least one caster wheel and a caster housing that has a base connection portion. A strain sensor plate has a first weight bearing side that is connected to the base connection portion and a second weight bearing side for connection to a provided base frame. The strain sensor plate defines a plate opening. A brake rod is moveable in a vertical direction within the plate opening.

According to another aspect of the present disclosure, a method of obtaining a patient's weight with a patient operating table includes a first step where a determination is made, with a level sensor, whether the patient operating table is inclined below a threshold to obtain an accurate measurement. Then, relative displacement between a first weight bearing side and a second weight bearing side is measured, with a strain gauge, to develop a baseline displacement. Next, a patient is placed on a support mattress of the patient operating table. Then, further relative displacement between the first weight bearing side and the second weight bearing side is measured with the strain gauge. Then, the patient's weight is obtained as a function of the further relative displacement.

According to another related aspect of the present disclosure, a patient operating table includes a patient support mattress configured to support a patient's weight. A base frame is configured to support the patient support mattress. A plurality of caster assemblies are connected to the base frame. Each caster assembly comprises at least one caster wheel, a strain sensor plate that defines a depression, and a control unit that is located in the depression and configured to determine a displacement of the strain sensor to obtain the patient's weight.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of an operating table that includes a weight sensing system provided among a plurality of caster assemblies, according to an aspect of the present disclosure;

FIG. 2 is a top perspective view of a caster assembly, according to an aspect of the present disclosure;

FIG. 3 is a top perspective view of a strain sensor plate, according to an aspect of the present disclosure;

FIG. 4 is a bottom perspective view of the strain sensor plate, according to an aspect of the present disclosure;

FIG. 5 is a bottom perspective view of a caster assembly, according to an aspect of the present disclosure;

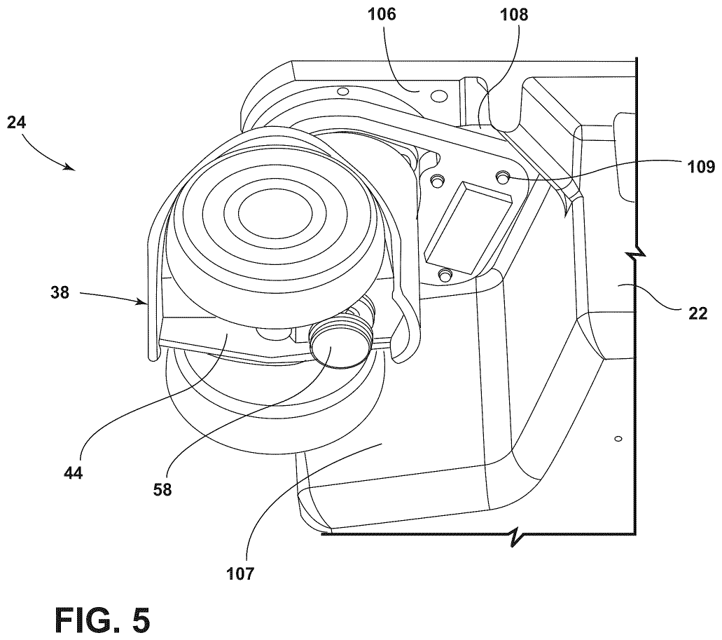

FIG. 6 is a top plan view of a caster assembly, according to an aspect of the present disclosure;

FIG. 7 is a bottom perspective view of a caster assembly with a caster wheel removed and illustrating a brake rod, according to an aspect of the present disclosure;

FIG. 8 is a side elevational view of a brake rod, according to an aspect of the present disclosure;

FIG. 9 schematically illustrates a weight sensing system, according to an aspect of the present disclosure; and

FIG. 10 illustrates a method of obtaining a patient's weight, according to an aspect of the present disclosure.

### DETAILED DESCRIPTION

The present illustrated embodiments reside primarily in combinations of method steps and apparatus components related to a patient operating table with a weight sensing system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

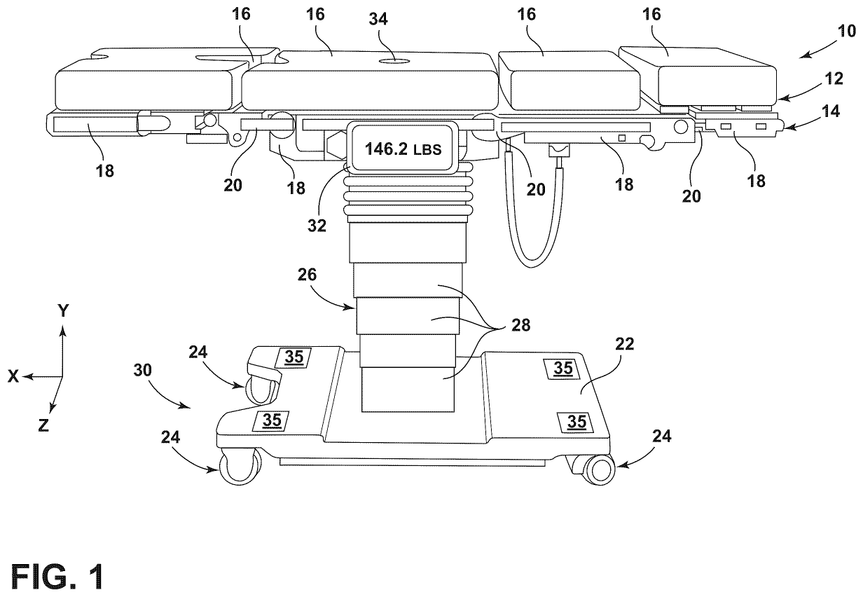

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface closest to an intended viewer, and the term “rear” shall refer to a surface furthest from the intended viewer. However, it is to be understood that the disclosure may assume various alternative orientations, except where expressly specified to the contrary. It is also to be understood that the specific structures and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring initially to FIG. 1, reference numeral 10 generally designates a patient operating table. The patient operating table 10 includes a patient support mattress 12 and a mattress support frame 14 that supports and positions the patient support mattress 12. In some embodiments, the patient support mattress 12 includes two or more (e.g., three, four, five, or six) cushions 16 and the mattress support frame 14 may include two or more sub-support frames 18 (e.g., three, four, five, or six). The sub-support frames 18 may be operably coupled by linkages 20 that permit articulation between adjacent sub-support frames 18 to position a patient in varying orientations. The patient operating table 10 further includes a base frame 22 that includes a plurality of caster assemblies 24 that allow the patient operating table 10 to roll between different locations in a medical facility (e.g., along an X-axis and a Z-axis). A central pedestal 26 operably connects the base frame 22 to the mattress support frame 14. The central pedestal 26 may be vertically (e.g., along a Y-axis) adjustable between a variety of positions to suit the needs of a caregiver. More particularly, the central pedestal 26 may include a series of telescopically adjustable sleeves 28. In some embodiments, the central pedestal 26 connects centrally on the base frame 22 between the caster assemblies 24 and centrally on the mattress support frame 14, such that a patient's center of mass is substantially aligned therewith. In some embodiments, a central wheel (not shown) may be located under the central pedestal 26 to facilitate movement around the medical facility. The central wheel may be self-driven via a motor to assist in movement along the X-axis and the Z-axis, and/or the like. The central wheel may be moveable between an operating position, supporting at least a portion of the patient's weight, and a stowed position, spaced from a floor of the medical facility and not supporting the patient's weight.

With continued reference to FIG. 1, the patient operating table 10 incorporates a weight sensing system 30 that includes the plurality of caster assemblies 24. The weight sensing system 30 accurately obtains a weight of a patient located on the patient operating table 10 and relays the obtained weight, allowing a caregiver the option to perform subsequent actions such as determining a dosing regimen. The weight sensing system 30 may further include a monitor 32 (e.g., a tablet, a display, a personal electronic device, and/or the like) that is paired to the patient operating table 10 in a wired or wireless configuration to display the obtained weight. It is contemplated that the monitor 32 may be configured to transmit the obtained weight to other components in the medical facility. For example, the monitor 32 may be configured to transmit the obtained weight to a medical record database. In some embodiments, the patient support mattress 12 may include an indicia 34 that is aligned with the central pedestal 26. The indicia 34 may function as a prompt to a caregiver to align a patient on the patient support mattress 12 such that the patient's center of mass (e.g., below and adjacent to their belly button) is substantially aligned with the indicia 34 and, as a result, also with the central pedestal 26. The weight sensing system 30 may further include one or more level sensors 35 to determine if the caster assemblies 24 are on an even, non-inclined surface (e.g., along a plane defined by the X-axis and the Z-axis). In some embodiments, the one or more level sensors 35 may include an accelerometer adjacent to each caster assembly 24. For example, the level sensors 35 may be located within or on each caster assembly 24, within or on corners of the base frame 22, within or on the central pedestal 26, and/or within or on the mattress support frame 14. As will be described in greater detail herein, when the caster assemblies 24 are located on an uneven surface, such as an incline, a non-planar topography, or the like, the weight sensing system 30 may be configured to account for an uneven distribution of weight to one or more particular caster assembly 24.

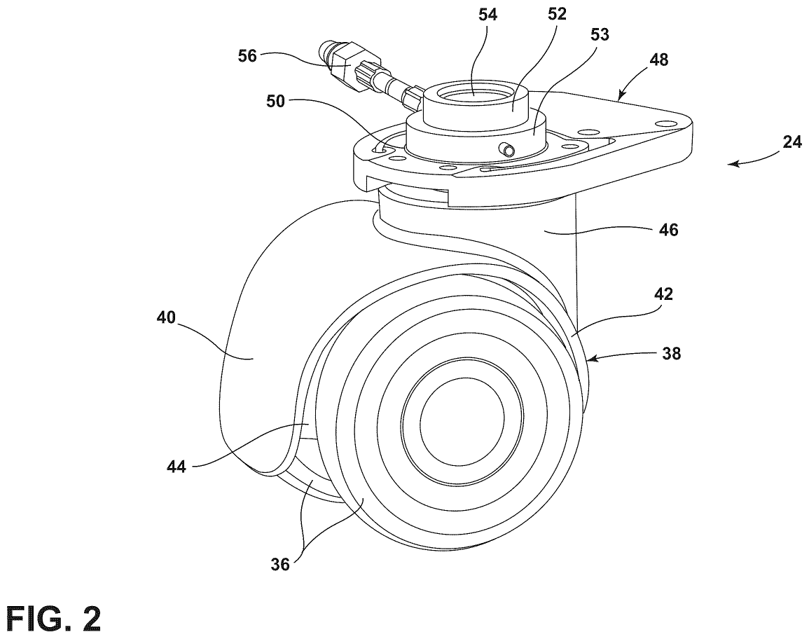

With reference now to FIG. 2, one exemplary construction of the caster assemblies 24 is provided. It will be appreciated that each caster assembly 24 may have the same features, elements, materials, and functionalities. The caster assembly 24 includes at least one caster wheel 36 (e.g., a pair of caster wheels) and a caster housing 38. The caster housing 38 includes a front shield portion 40 and a rear shield portion 42 that, together, protect the at least one caster wheel 36 and provide a vertical clearance. The caster housing 38 may also include a divider plate 44 located between each of the caster wheels 36. Each caster wheel 36 is connected to the divider plate 44 for rotation. The caster housing 38 further includes a base connection portion 46 for operable connection to the base frame 22. The caster housing 38 and the caster wheels 36 may be rotationally connected with respect to the base frame 22 (e.g., parallel to the Y-axis in FIG. 1). A strain sensor plate 48 is connected to the base connection portion 46 of the caster housing 38. The strain sensor plate 48 defines a plate opening 50. An internal collar 52 is aligned with the plate opening 50 on a side of the strain sensor plate 48 opposite the caster housing 38.

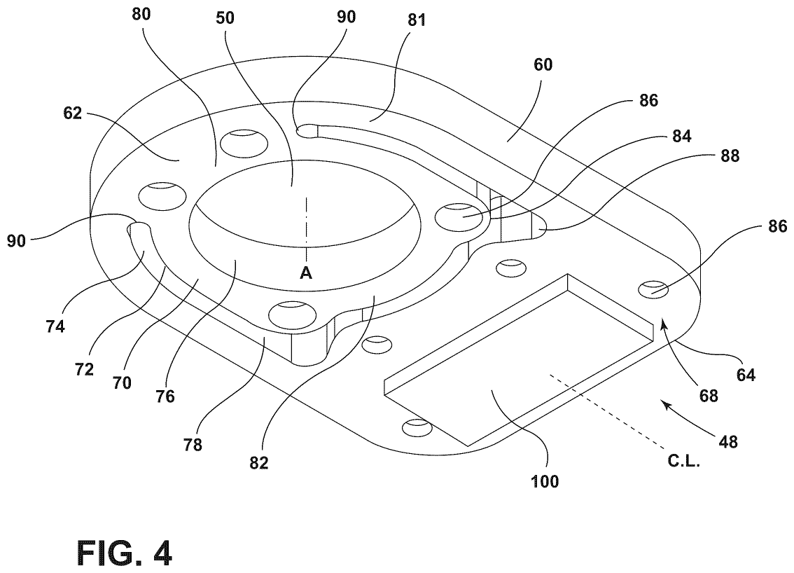

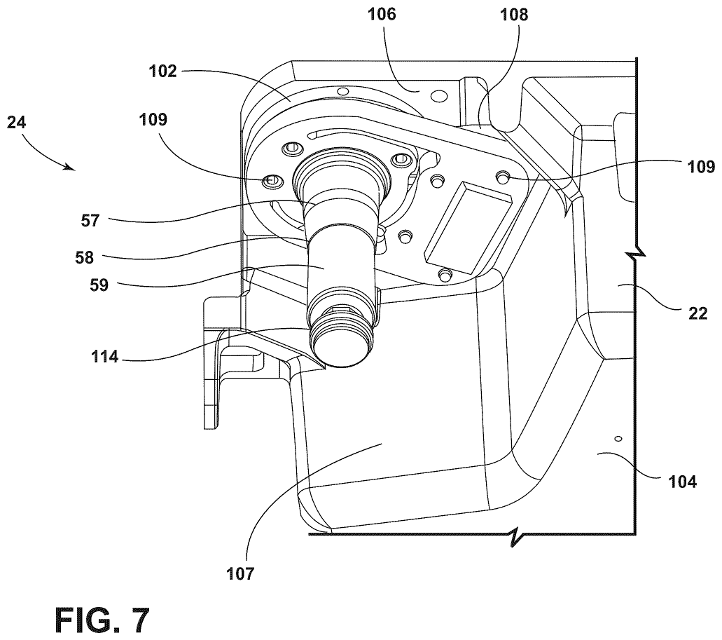

With continued reference to FIG. 2, a table lift connection 56 is operably connected to the internal collar 52. In some embodiments, the table lift connection 56 introduces fluid into the caster assembly 24 via a fluid circuit (e.g., a hydraulic circuit, pneumatic circuit, and/or the like). More particularly, the internal collar 52 defines a collar opening 54 and the caster housing 38 defines a housing opening aligned with both the collar opening 54 and the plate opening 50. A brake rod 58 (FIGS. 4, 7, and 8) is moveable (e.g., via the fluid circuit) through each of the plate and collar openings 50, 54 until it contacts a floor of the medical facility and lifts the other components off the patient operating table 10 in a parked position. In the parked position, a caregiver can transfer the patient to and from the patient operating table 10 or otherwise perform certain tasks without the patient operating table 10 moving. The internal collar 52 may include an outer flare 53 toward a bottom surface thereof. In some embodiments, the brake rod 58 may include a fixed portion 57 (FIG. 7) rigidly fixed to the internal collar 52 and a moveable portion 59 (FIG. 7) that extends and retracts (e.g., telescopically) relative to the fixed portion 57 via operation of the fluid circuit.

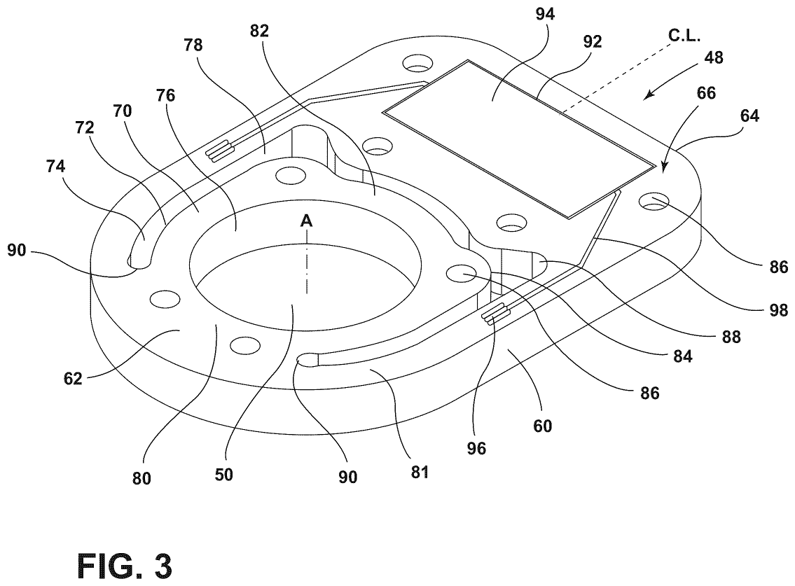

Referring now to FIG. 3, a strain sensor plate 48 is shown. The strain sensor plate 48 includes an outer plate perimeter 60 that partially defines a first weight bearing side 62 and a second weight bearing side 64 that is offset from the first weight bearing side 62 in the horizontal direction (e.g., the X-axis). The caster housing 38 is operably coupled to the first weight bearing side 62, and the base frame 22 is operably coupled to the second weight bearing side 64. As such, strain is imparted between the first and second weight bearing sides 62, 64 and is increased upon the addition of a patient's weight. By measuring a difference in the strain before and after a patient is placed thereon, an accurate weight of the patient can be obtained. Likewise, changes in strain can indicate a change in the weight of the patient.

With continued reference to FIG. 3, the outer plate perimeter 60 may define a Norman window-type shape, that may also be described as a semi-circle merging into a rectangle. In some embodiments, the first weight bearing side 62 defines the semi-circular portion of the outer plate perimeter 60 and the second weight bearing side 64 defines at least part of the rectangular portion of the outer plate perimeter 60. The rectangular portion of the outer plate perimeter 60 may define a pair of curved corners opposite the semi-circular portion of the outer plate perimeter 60. The strain sensor plate 48 includes an upper surface 66 (FIG. 3) that faces the base frame 22 and a lower surface 68 (FIG. 4) that faces the caster housing 38. The first weight bearing side 62 may include a flex spring 70 located within the outer plate perimeter 60. The flex spring 70 includes an outer spring perimeter 72 that at least partially defines a channel 74 that extends through both the upper surface 66 and the lower surface 68. The channel 74 may be curved. The flex spring 70 further includes an inner spring perimeter 76 that at least partially defines the plate opening 50. Also, the strain sensor plate 48 may include an inner plate perimeter 78 that, together with the outer spring perimeter 72, defines the channel 74. The outer spring perimeter 72, the inner plate perimeter 78, and the channel 74 defined therebetween may be symmetric through a center line “C.L.” that extends centrally through both the first weight bearing side 62 and the second weight bearing side 64. In some embodiments, the strain sensor plate 48 in its entirety is also symmetric through the center line “C.L.”

The outer spring perimeter 72 may be partially circular and the inner spring perimeter 76 may be substantially circular and extend about a central axis A such that the flex spring 70 is at least partially annular in shape. For example, the outer spring perimeter 72 may extend from a coextensive portion 80 that connects to arms 81 of the first weight bearing side 62 along a freestanding portion 82. The freestanding portion 82 may extend circumferentially between 180° and 360°. In one example, the freestanding portion 82 extends more than 270° with respect to the central axis A. In other words, the at least partially annular shaped flex spring 70 may also be defined as a horseshoe shape. A width of the flex spring 70 between the outer spring perimeter 72 and the inner spring perimeter 76 may be substantially uniform except for widened portions 84 that each define one or more bores 86 (e.g., a pair of bores) to facilitate connection. The widened portions 84 may be defined by the outer spring perimeter 72 and be semi-circular, with the bore 86 located substantially centrally between the outer spring perimeter 72 and the inner spring perimeter 76. The coextensive portion 80 may also define one or more bores 86 (e.g., a pair of bores) to facilitate connection. In some embodiments, the bores 86 defined by the coextensive portion 80 are located closer relative to one another than a relative spacing between the bores 86 defined by the widened portions 84. In some embodiments, the inner plate perimeter 78 includes recesses 88 adjacent to the widened portions 84. In some embodiments, a space (e.g., the channel 74) between the outer spring perimeter 72 and the inner plate perimeter 78 is substantially uniform around the freestanding portion 82 but includes larger spacing between the widened portions 84 and the recesses 88. The channel 74 may include a pair of opposite terminal ends 90 at the coextensive portion 80 wherein the spacing between the outer spring perimeter 72 and the inner plate perimeter 78 is larger than other portions of the channel 74 but smaller than the spacing between the widened portions 84 and the recesses 88.

With reference once again to FIG. 2, the outer flare 53 of the internal collar 52 sits on the freestanding portion 82. An exterior surface of the outer flare 53 may be located within the inner plate perimeter 78. In some embodiments, the exterior surface of the outer flare 53 is located between the inner spring perimeter 76 and the inner plate perimeter 78. In other embodiments, the exterior surface of the outer flare 53 is located between the inner spring perimeter 76 and the outer spring perimeter 72. Therefore, weight imparted on the internal collar 52 from the patient operating table 10 may cause the second weight bearing side 64 to bend (i.e., to be displaced) relative to the flex spring 70. In some embodiments, the outer flare 53 may be rigidly fixed to one or both of the flex spring 70 and the fixed portion 57 of the brake rod 58. In this manner, the weight sensing system 30 may be able to obtain the weight of the patient when the brake rod 58 is in the parked position (e.g., via weight imparted by the outer flare 53 on the flex spring 70) and the unparked position (e.g., via weight imparted by the caster wheel 36 on the flex spring 70).

The second weight bearing side 64 may also define one or more bores 86 (e.g., two pairs of bores) to facilitate connection. In some embodiments, a bore 86 is located next to each recess 88 on a side of the center line “C.L.” and a bore 86 is located next to each of the curved corners of the outer plate perimeter 60. A depression 92 may be at least partially located between the bores 86 defined by the second weight bearing side 64. The depression 92 may be defined by the upper surface 66. A control unit 94 (e.g., a micro-controller) is located in the depression 92 such that a top surface thereof is flush or slightly recessed from the upper surface 66. At least one strain gauge 96 is operably coupled to the control unit 94 via at least one conductor 98 (e.g., conductive traces or wires). The strain gauge 96 may include a pair of strain gauges 96 located between the outer plate perimeter 60 and the inner plate perimeter 78. For example, each strain gauge 96 is located on the arms 81 of the second weight bearing side 64 on opposite sides of the freestanding portion 82 of the flex spring 70. More particularly, each strain gauge 96 may be aligned with the widened portions 84. The at least one strain gauge 96 may be configured to measure a force imparted thereon, a magnitude of displacement of the arms 81 relative to the freestanding portion 82 of the flex spring 70, and/or the like.

Referring now to FIG. 4, the lower surface 68 of the strain sensor plate 48 is illustrated. The lower surface 68 may define a control housing 100 that extends therefrom to accommodate a control unit 94 that is thicker than the distance between the upper surface 66 and the lower surface 68. In some embodiments, the upper surface 66 and the lower surface 68 are planar and parallel. In other embodiments, the upper surface 66 and the lower surface 68 are planar and parallel other than the control housing 100. In other embodiments, the flex spring 70 defines a thickness that is less than a thickness defined by the second weight bearing side 64 (FIG. 2). The strain sensor plate 48, other than the control unit 94, the at least one strain gauge 96, and the at least one conductor 98 may be an integrally formed unit. In some embodiments, the strain sensor plate 48 is formed via a stamping process. In some embodiments, the strain sensor plate 48 is formed of a material that contains iron and carbon with one or more other metals or nonmetals.

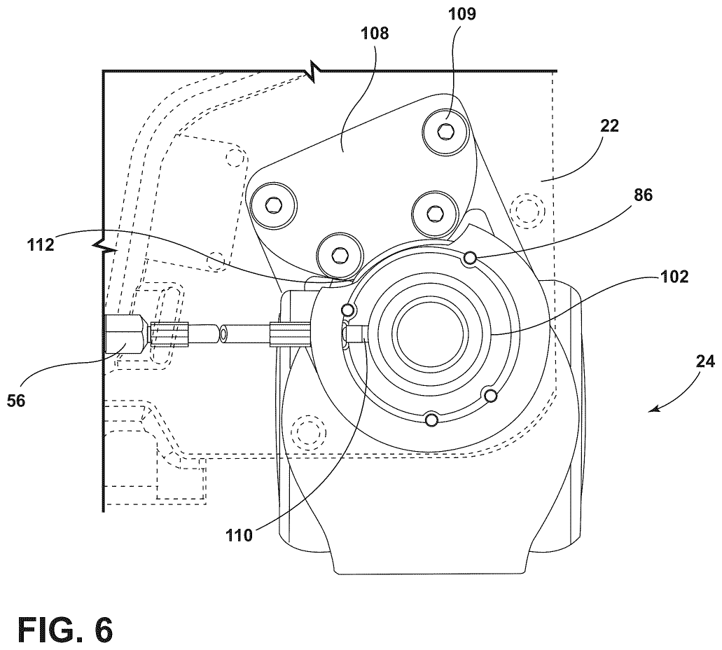

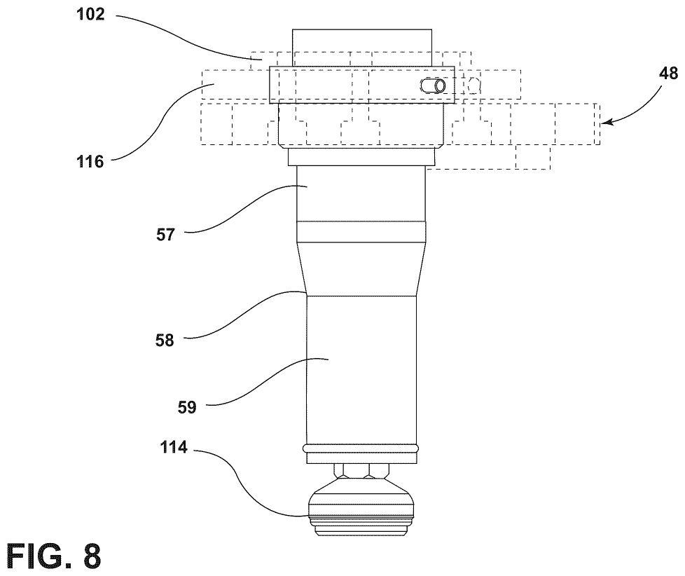

With reference now to FIGS. 6-8, the caster assembly 24 is further illustrated. An external collar 102 is provided over the internal collar 52 and sandwiches the flex spring 70 between the external collar 102 (FIG. 7) and the base connection portion 46 of the caster housing 38. Therefore, in some embodiments, the flex spring 70 is held constant and the displacement occurs primarily in the arms 81 of the second weight bearing side 64. The base frame 22 includes an under frame surface 104 that may define a cradle-type shape with flat corners 106 and a sidewall 107 that extends about the flat corners 106 in a downward direction to define a pocket. A connector plate 108 may sit on the second weight bearing side 64 and be connected thereto with a fastener 109 in each bore 86. FIG. 7 illustrates the caster assembly 24 with the at least one caster wheel 36 removed. The brake rod 58 may include an adjustable boot 114 that can be adjusted in the vertical direction (e.g., the Y-axis). FIG. 8 further illustrates the brake rod 58. The external collar 102 may include a bottom flange 116 that defines the bay 112.

With reference now to FIGS. 7 and 8, additional features of the external collar 102 and the connector plate 108 are illustrated. The connector plate 108 may define an oblong shape that is substantially aligned with and follows at least a portion of the outer plate perimeter 60 and the inner plate perimeter 78. The connector plate 108 and the flat corners 106 may further define apertures such that the fasteners 109 extend through the connector plate 108, the flat corners 106, and the second weight bearing side 64. The external collar 102 may define a fluid channel 110 in fluid communication with the table lift connection 56. The external collar 102 may further define a substantially circular exterior surface with a bay 112. In some embodiments, the connector plate 108 is at least partially located in the bay 112. The external collar 102 may further include bores 86 substantially aligned with the bores 86 on the first weight bearing side 62 (e.g., the flex spring 70 and the coextensive portion 80), such that fasteners 109 can be connected thereto.

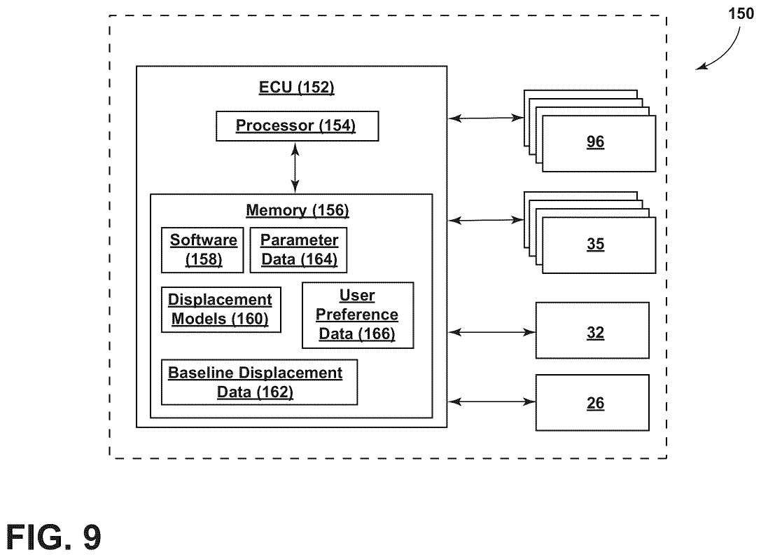

FIG. 9 schematically illustrates a control system 150 of the weight sensing system 30. The control system 150 may include an electronic control unit (ECU) 152. The ECU 152 may be a plurality of ECUs 152, such as the control units 94, or may be a global ECU 152 in wired or wireless communication with the control units 94. The ECU 152 may include a processor 154 and a memory 156. The processor 154 may include any suitable processor to support a weight sensing system. Additionally, or alternatively, the ECU 152 may include any suitable number of processors, in addition to or other than the processor 154. The memory 156 may comprise a single disk or a plurality of disks (e.g., hard drives) and includes a storage management module that manages one or more partitions within the memory 156. In some embodiments, the memory 156 may include flash memory, semiconductor (solid-state) memory, or the like. The memory 156 may include Random Access Memory (RAM), a Read-Only Memory (ROM), Electrically Erasable Programmable Read-Only Memory (EEPROM), or a combination thereof. The memory 156 may include instructions that, when executed by the processor 154, cause the processor 154 to, at least, perform the functions associated with the components of the weight sensing system 30. The at least one strain gauge 96, the at least one level sensor 35, and the monitor 32 may therefore be controlled and/or receive instructions from the ECU 152. The memory 156 may therefore include software 158, displacement models 160 (i.e., with added patient weight), baseline displacement data 162 (i.e., without added patient weight), parameter data 164, and user preference data 166.

With continued reference to FIG. 9, the weight sensing system 30 may be configured to perform method steps as described herein. For example, the displacement models 160 may include conversions of displacement of the strain sensor plate 48 to accurately obtain a patient's weight. The parameter data 164 may include level information such as if the caster assemblies 24 are on an inclined or non-inclined surface (e.g., along a plane defined by the X-axis and the Z-axis) as obtained from the at least one level sensor 35. The parameter data 164 may further include a first threshold angle of inclination between two or more caster assemblies 24 wherein a patient's weight cannot be accurately obtained (e.g., 5 or more degrees, 10 or more degrees, 15 or more degrees, or 20 or more degrees). Therefore, if the angle of inclination is above the first threshold, the ECU 152 may generate a visual or audible warning (e.g., via the monitor). In a like manner, the parameter data 164 may further include a second threshold angle of inclination that relates to a risk of tipping. The second threshold angle of inclination may be associated with an extension of the central pedestal 26, a weight obtained by the strain sensor plate 48, and/or the like. In instances wherein an angle of inclination is present but below the first threshold angle of inclination, a coefficient may be used with the displacement models 160 based on the angle of inclination. User preference data 166 may include, for example, communicating an obtained patient's weight, using the obtained patient's weight to generate a recommended regimen of dosing, monitoring a patient's weight and generating a warning upon a loss or gain of weight associated with blood loss or fluid buildup, and/or the like. The baseline displacement data 162 may be monitored to determine if the magnitude of displacement remains consistent. For example, if the baseline displacement data 162 changes over repeated use, the software 158, the displacement models 160, and the parameter data 164 may be updated.

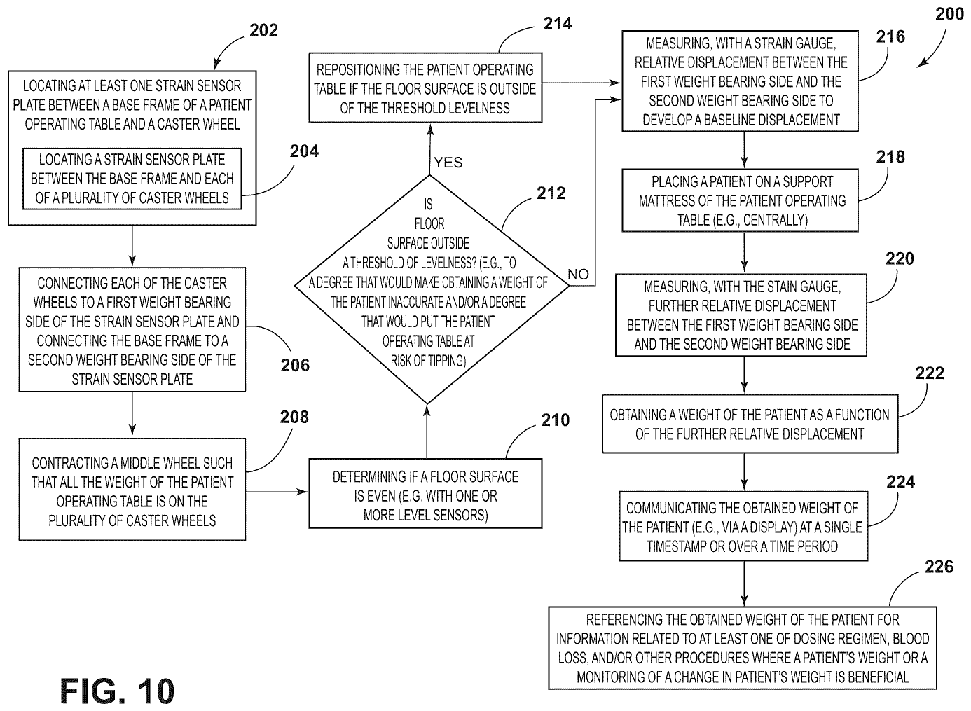

FIG. 10 illustrates a method 200 of obtaining a patient's weight. At step 202 of the method 200, at least one strain sensor plate 48 is located between the base frame 22 of the patient operating table 10 and the caster wheel 36. Step 202 may include step 204, where the strain sensor plate 48 is located between the base frame 22 and each of the plurality of caster wheels 36. Next, at step 206, each of the caster wheels 36 is connected to the first weight bearing side 62 of the strain sensor plate 48 and the base frame 22 is connected to the second weight bearing side 64 of the strain sensor plate 48. In some embodiments, the first weight bearing side 62 and the second weight bearing side 64 may be offset. At step 208, a middle wheel is contracted (e.g., into the stowed position) such that all the weight of the patient operating table 10 is on the plurality of caster wheels 36. At step 210, the method 200 includes determining if a floor surface is even (e.g., with one or more level sensors). At step 212 of the method 200, a warning is generated if the floor surface is outside of a threshold levelness (e.g., to a degree that would make obtaining a patient's weight inaccurate and/or to a degree that would put the patient operating table 10 at risk of tipping). If the floor surface is determined to be outside of the threshold levelness, the patient operating table 10 will be repositioned, at step 214, before moving to step 216. If the floor surface is determined to be within the threshold levelness, or after the patient operating table is repositioned in step 214, at step 216, a relative displacement between the first weight bearing side 62 and the second weight bearing side 64 is then measured, with the strain gauge 96, to develop a baseline displacement. At step 218 a patient is placed (e.g., centrally) on the support mattress 12 of the patient operating table 10. Next, at step 220, further relative displacement between the first weight bearing side 62 and the second weight bearing side 64 is measured with the strain gauge 96. At step 222, a patient's weight is obtained as a function of the further relative displacement. Then, at step 224, the obtained weight of the patient is communicated (e.g., via a monitor) at a single timestamp or over a time period. Finally, at step 226, caregivers may reference the obtained weight of the patient for information related to at least one of a dosing regimen, blood loss, and/or other procedures where a patient's weight or a monitoring of a change in a patient's weight is beneficial to care.

The patient operating table 10 and components thereof may be configured to perform the functionalities and methods described herein. For example, the weight sensing system 30 may be configured (e.g., via the level sensors 35) to determine an inclination of the patient operating table 10. The weight sensing system 30 may further be configured to determine if the inclination is above a first threshold of inclination angle or a second level of inclination angle (e.g., via the level sensors 35 and parameter data 164). If the inclination of the patient operating table 10 is above the first threshold of inclination angle, the weight sensing system 30 may further be configured to generate a request to reposition the patient operating table 10. If the inclination of the patient operating table is above the second threshold of inclination angle, the weight sensing system 30 may further be configured to generate a warning to secure and cease movement of the patient operating table 10. The weight sensing system 30 may further be configured to obtain a weight of the patient (e.g., via the strain sensor plate 48 and/or strain gauge 96). The weight sensing system 30 may further be configured to recommend a regimen or generate a warning based on the obtained weight or a change of the obtained weight over a period of time (e.g., via the monitor 32). These and other structural and non-structural functionalities, as described herein, are therefore fully supported by the present disclosure.

The disclosure described herein is further summarized in the following paragraphs and is further characterized by combinations of any and all of the various aspects described therein.

According to one aspect of the present disclosure, a patient operating table includes a patient support mattress for supporting a patient's weight. A base frame supports the patient support mattress. A plurality of caster assemblies are connected to the base frame. Each caster assembly includes at least one caster wheel and a strain sensor plate with a first weight bearing side that includes a flex spring with an annular shape that is located at least partially within an outer perimeter of the stain sensor plate and a second weight bearing side. The first weight bearing side is operably coupled to the at least one caster wheel and the second weight bearing side is operably coupled to the base frame support. As such, weight imparted from the base frame passes from the second weight bearing side to the first weight bearing side.

According to another aspect of the present disclosure, a strain sensor plate includes a strain gauge to measure a magnitude of displacement.

According to yet another aspect of the present disclosure, a strain sensor plate defines a depression. A control unit that is in operable communication with a strain gauge is located in the depression.

According to another aspect of the present disclosure, a strain sensor plate includes a lower surface and an upper surface. The lower surface defines a control housing that extends therefrom to at least partially define a depression. The control unit is one of flush or recessed from the upper surface.

According to yet another aspect of the present disclosure, a strain gauge includes a pair of strain gauges that are located symmetrically from a center line of a strain plate.

According to another aspect of the present disclosure, a first weight bearing side and a second weight bearing side are offset in a horizontal direction.

According to still another aspect of the present disclosure, a flex spring is located entirely within an outer perimeter of a strain sensor plate.

According to another aspect of the present disclosure, a flex spring includes a freestanding portion that defines an annular shape and extends from a coextensive portion of a strain sensor plate and defines a curved channel within an outer perimeter.

According to yet another aspect of the present disclosure, a first weight bearing side and a second weight bearing side are integral.

According to another aspect of the present disclosure, a strain sensor plate is symmetric along a center line that extends through a first weight bearing side and a second weight bearing side.

According to yet another aspect of the present disclosure, a patient operating table includes a monitor that is in communication with a strain sensor plate to present units of weight imparted from a first weight bearing side to a second weight bearing side.

According to another aspect of the present disclosure, one or more level sensors are located on or in a patient operating table.

According to still another aspect of the present disclosure, one or more level sensors include a plurality of accelerometers.

According to another aspect of the present disclosure, a caster assembly for a patient operating table includes at least one caster wheel and a caster housing that has a base connection portion. A strain sensor plate has a first weight bearing side that is connected to the base connection portion and a second weight bearing side for connection to a provided base frame. The strain sensor plate defines a plate opening. A brake rod is moveable in a vertical direction within the plate opening.

According to yet another aspect of the present disclosure, a strain sensor plate includes a flex spring and the flex spring defines a plate opening.

According to another aspect of the present disclosure, a strain sensor plate includes a strain gauge.

According to another aspect of the present disclosure, a method of obtaining a patient's weight with a patient operating table includes a first step where a determination is made, with a level sensor, whether the patient operating table is inclined below a threshold to obtain an accurate measurement. Then, relative displacement between a first weight bearing side and a second weight bearing side is measured, with a strain gauge, to develop a baseline displacement. Next, a patient is placed on a support mattress of the patient operating table. Then, further relative displacement between the first weight bearing side and the second weight bearing side is measured with the strain gauge. Then, the patient's weight is obtained as a function of the further relative displacement.

According to another related aspect of the present disclosure, a method of obtaining a patient's weight with a patient operating table includes a step where an obtained patient's weight is referenced to determine a dosing regimen.

According to yet another related aspect of the present disclosure, a method of obtaining a patient's weight with a patient operating table includes a step where, with at least one level sensor, determine if the patient operating table is on a floor surface with a threshold levelness such that obtaining the patient's weight is accurate

According to another related aspect of the present disclosure, a patient operating table includes a patient support mattress configured to support a patient's weight. A base frame is configured to support the patient support mattress. A plurality of caster assemblies are connected to the base frame. Each caster assembly comprises at least one caster wheel, a strain sensor plate that defines a depression, and a control unit that is located in the depression and configured to determine a displacement of the strain sensor to obtain the patient's weight.

According to still another aspect of the present disclosure, a control unit is configured to generate an obtained patient's weight on a monitor.

According to yet another aspect of the present disclosure, a strain sensor includes a first weight bearing side and a second weight bearing side. The second weight bearing side is configured to be displaced from the first weight bearing side in correlation to the patient's weight.

According to another aspect of the present disclosure, a first weight bearing side includes a flex spring that is operably connected to at least one caster wheel. The flex spring is configured to facilitate displacement between the first weight bearing side and a second weight bearing side.

According to still another aspect of the present disclosure, at least one level sensor is configured to determine if a patient operating table is on a floor surface with a threshold levelness such that obtaining a patient's weight is accurate.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A patient operating table comprising:
a patient support mattress for supporting a patient's weight;
a base frame supporting the patient support mattress; and
a plurality of caster assemblies connected to the base frame, each caster assembly comprising:
at least one caster wheel; and
a strain sensor plate having a first weight bearing side that includes a flex spring with an annular shape that is located at least partially within an outer perimeter of the strain sensor plate and a second weight bearing side, wherein the first weight bearing side is operably coupled to the at least one caster wheel and the second weight bearing side is operably coupled to the base frame support, and wherein weight imparted from the base frame passes from the second weight bearing side to the first weight bearing side.

2. The patient operating table of claim 1, wherein the strain sensor plate includes a strain gauge for measuring a magnitude of displacement.

3. The patient operating table of claim 2, wherein the strain sensor plate defines a depression and a control unit in operable communication with the strain gauge is located in the depression.

4. The patient operating table of claim 3, wherein the strain sensor plate includes a lower surface and an upper surface, the lower surface defining a control housing extending therefrom to at least partially define the depression, wherein the control unit is one of flush or recessed from the upper surface.

5. The patient operating table of claim 2, wherein the strain gauge includes a pair of strain gauges located symmetrically from a center line of the strain plate.

6. The patient operating table of claim 1, wherein the first weight bearing side and the second weight bearing side are offset in a horizontal direction.

7. The patient operating table of claim 1, wherein the flex spring is located entirely within the outer perimeter of the strain sensor plate.

8. The patient operating table of claim 1, wherein the flex spring includes a freestanding portion defining the annular shape and that extends from a coextensive portion of the strain sensor plate and defines a curved channel within the outer perimeter.

9. The patient operating table of claim 8, wherein the first weight bearing side and the second weight bearing side are integral.

10. The patient operating table of claim 8, wherein the strain sensor plate is symmetric along a center line extending through the first weight bearing side and the second weight bearing side.

11. The patient operating table of claim 1, further comprising:
a monitor in communication with the strain sensor plate for presenting units of the weight imparted from the first weight bearing side to the second weight bearing side.

12. The patient operating table of claim 1, further including one or more level sensors.

13. The patient operating table of claim 12, wherein the one or more level sensors include a plurality of accelerometers.

14. A caster assembly for a patient operating table comprising:
at least one caster wheel;
a caster housing including a base connection portion;
a strain sensor plate having a first weight bearing side connected to the base connection portion and a second weight bearing side for connection to a provided base frame, wherein the strain sensor plate defines a plate opening; and
a brake rod moveable in a vertical direction within the plate opening.

15. The caster assembly of claim 14, wherein the strain sensor plate includes a flex spring, the flex spring defining the plate opening.

16. The caster assembly of claim 15, wherein the strain sensor plate includes an outer perimeter and the flex spring is located within the outer perimeter.

17. The caster assembly of claim 14, wherein the strain sensor plate includes a strain gauge.

18. A method of obtaining a patient's weight with a patient operating table, the method comprising the steps of:
determining, with a level sensor, if the patient operating table is inclined below a threshold to obtain an accurate measurement;
measuring, with a strain gauge, relative displacement between a first weight bearing side and a second weight bearing side to develop a baseline displacement;
placing a patient on a support mattress of said patient operating table;
measuring, with the strain gauge, further relative displacement between the first weight bearing side and the second weight bearing side; and
obtaining said patient's weight as a function of the further relative displacement.

19. The method of claim 18, further including referencing the obtained patient's weight to determine a dosing regimen.

20. The method of claim 18, further comprising:
with at least one level sensor, determine if the patient operating table is on a floor surface with a threshold levelness such that obtaining the patient's weight is accurate.
